(19) United States
(12) Patent Application Publication
(10) Pub. No.: US 2025/0253357 A1
(43) Pub. Date: Aug. 7, 2025

(54) SEPARATOR FOR FUEL CELLS AND FUEL CELL INCLUDING THE SAME

(71) Applicant: University of Seoul Industry Cooperation Foundation, Seoul (KR)

(72) Inventors: Youngseung NA, Seoul (KR); Seongsu IM, Seoul (KR)

(21) Appl. No.: 19/046,928

(22) Filed: Feb. 6, 2025

(30) Foreign Application Priority Data
Feb. 7, 2024 (KR) 10-2024-0019192

(51) Int. Cl. H01M 8/0263; H01M 8/0247

(52) U.S. Cl. CPC H01M 8/0263; H01M 8/0247

(57) ABSTRACT

Disclosed herein may be a separator for fuel cells, including a body plate, and a serpentine flow channel formed on one surface of the body plate. The serpentine flow channel may include a first main flow channel formed with a first width, a second main flow channel spaced apart from the first main flow channel and formed with a second width, and a bent flow channel connected at one end thereof to the first main flow channel, and connected at another end thereof to the second main flow channel. The first width may be greater than the second width.

### CROSS-REFERENCE TO RELATED APPLICATION

The present application claims priority to and the benefit of Korean Patent Application No. 10-2024-0019192, filed on Feb. 7, 2024, in the Korean Intellectual Property Office, the entire disclosure of which is incorporated herein by reference.

### FIELD

The present disclosure relates to a separator for fuel cells capable of improving current density, and a fuel cell including the separator.

### BACKGROUND

Polymer electrolyte membrane fuel cells (PEMFCs) generate electric power through a process in which hydrogen supplied to an anode is ionized and passes through an electrolyte membrane, and then is reduced by oxygen at a cathode to produce water molecules.

When a limited amount of fuel or oxidant (hereinafter referred to as “gas”) is supplied, the amount of power generated by a fuel cell is proportional to a current density of the fuel cell. The current density improves as a loss of the supplied gas during a process of reaching a membrane electrode assembly (MEA) decreases, or as gas is uniformly transferred across an entire area.

On the other hand, in the case where gas supplied to an inlet of a separator does not effectively reach the MEA, there arises a problem in which the current density decreases, thereby reducing the performance of the fuel cell.

### PRIOR ART LITERATURE

### Patent Document

Korean Patent Publication No. 2023-0007244 A (Jan. 12, 2023)

### SUMMARY

An object of the present disclosure is to provide a separator for fuel cells and a fuel cell including the separator, in which convection of gas between adjacent flow channels in the separator and diffusion of gas into a gas diffusion layer may be facilitated, thereby improving a current density of the fuel cell.

A separator for fuel cells according to an embodiment of the present disclosure may include a body plate, and a serpentine flow channel formed on one surface of the body plate. The serpentine flow channel may include a first main flow channel formed with a first width, a second main flow channel spaced apart from the first main flow channel and formed with a second width, and a bent flow channel connected at one end thereof to the first main flow channel, and connected at another end thereof to the second main flow channel. The first width may be greater than the second width.

The separator according to an embodiment of the present disclosure may further include a rib enclosed by the first main flow channel, the second main flow channel, and the bent flow channel.

In the separator according to an embodiment of the present disclosure, the first main flow channel and the second main flow channel may be alternately arranged along one direction.

In the separator according to an embodiment of the present disclosure, the serpentine flow channel may include a plurality of serpentine flow channels. The first main flow channel of one serpentine flow channel of a pair of adjacent serpentine flow channels among the plurality of serpentine flow channels may be alternately arranged with the second main flow channel of a remaining serpentine flow channel of the pair of adjacent serpentine flow channels.

In the separator according to an embodiment of the present disclosure, the separator may further include a first flow channel assembly and a second flow channel assembly each including the plurality of serpentine flow channels.

In the separator according to an embodiment of the present disclosure, the first flow channel assembly and the second flow channel assembly may be symmetrical with each other.

In the separator according to an embodiment of the present disclosure, an arrangement order of the first main flow channel and the second main flow channel in the first flow channel assembly may be opposite to an arrangement order of the first main flow channel and the second main flow channel in the second flow channel assembly.

In the separator according to an embodiment of the present disclosure, the serpentine flow channel further comprises a modified section in which the width of the first main flow channel is reduced to the second width, or the width of the second main flow channel is increased to the first width.

A fuel cell according to an embodiment of the present disclosure may include a membrane electrode assembly, a gas diffusion layer formed on at least one surface of the membrane electrode assembly, and a separator configured to supply gas to the gas diffusion layer. The separator may be the separator according to any one of the aforementioned embodiments.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings.

FIG. 1 is an exploded perspective view illustrating a polymer electrolyte membrane fuel cell.

FIG. 2A is a front view illustrating a separator according to a first embodiment of the present disclosure.

FIG. 2B is a sectional view illustrating a cross section on a yz plane of area A shown in FIG. 2A.

FIG. 3 is a front view illustrating a separator according to a second embodiment of the present disclosure.

FIG. 4 is a graph comparing an average differential pressure in a flow channel of the separator in the second embodiment with that in the prior art.

FIG. 5A is a diagram comparing a flow velocity of gas in a gas diffusion layer between the second embodiment and the prior art.

FIG. 5B is a graph numerically comparing the flow velocity shown in FIG. 5A.

FIG. 6A is a diagram comparing a current density between the second embodiment and the prior art.

FIG. 6B is a graph numerically comparing the current density shown in FIG. 6A.

FIG. 7 is a front view illustrating a separator according to a third embodiment of the present disclosure.

FIG. 8A is a diagram comparing a flow velocity of gas in a gas diffusion layer between the third embodiment and the prior art.

FIG. 8B is a graph numerically comparing the flow velocity shown in FIG. 8A.

FIG. 9A is a diagram comparing a current density between the third embodiment and the prior art.

FIG. 9B is a graph numerically comparing the current density shown in FIG. 9A.

FIG. 10 is a front view illustrating a separator according to a fourth embodiment of the present disclosure.

### DETAILED DESCRIPTION

Since the present disclosure may be modified in various forms, and may have various embodiments, preferred embodiments will be illustrated in the accompanying drawings and described in detail with reference to the drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terminology used herein is for the purpose of describing particular embodiments only and is not intended to be limiting the present disclosure. In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, embodiments of the present disclosure will be described in detail with reference to the accompanying drawings. Reference now should be made to the drawings, in which the same reference numerals are used throughout the different drawings to designate the same or similar components. Details of well-known configurations and functions may be omitted to avoid unnecessarily obscuring the gist of the present disclosure. For the same reason, in the accompanying drawings, some elements are enlarged, omitted, or depicted schematically.

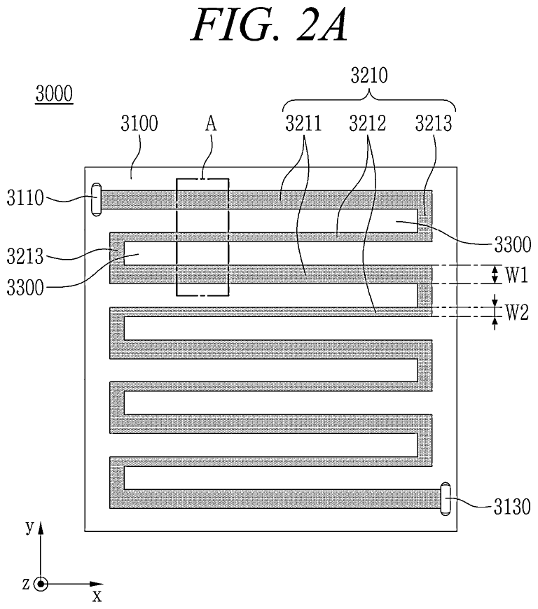

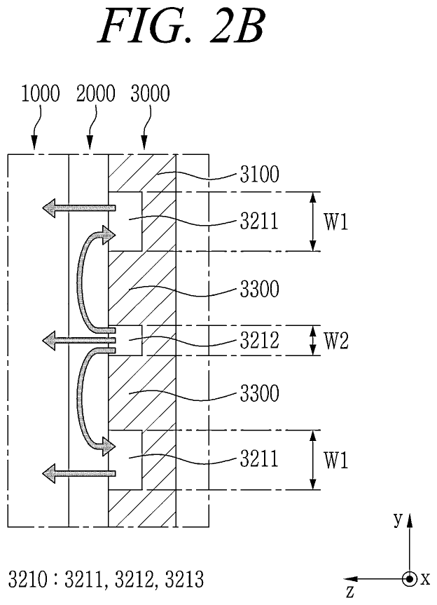

First, x, y, and z directions described in the present specification are explained with reference to FIG. 2A.

Referring to FIG. 2A, the x-direction indicates a direction in which gas flows along main flow channels 3211 and 3212 on a plane of a separator 3000.

The y direction refers to a direction that is oriented from any one of the main flow channels 3211 and 3212 to a different main flow channel 3211 or 3212 on the plane of the separator 3000 and is perpendicular to the x direction.

The z direction refers to a direction that extends forward from or backward into the plane of the separator 3000. A +z direction indicates a direction toward a gas diffusion layer 2000 (refer to FIG. 2B) from the separator 3000, and a −z direction indicates a direction away from the gas diffusion layer 2000 (refer to FIG. 2B).

Hereinafter, a fuel cell to which a separator according to a first embodiment of the present invention is applied will be described.

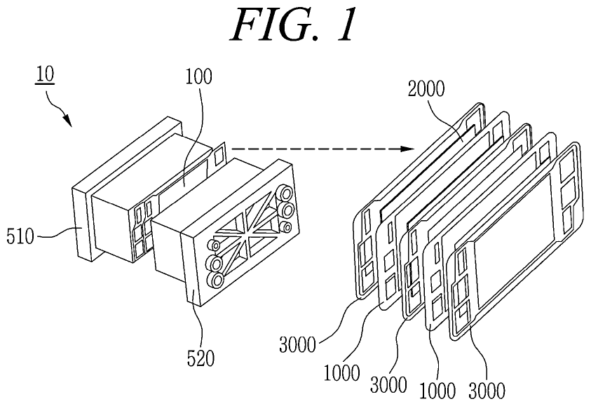

FIG. 1 is an exploded perspective view illustrating a polymer electrolyte membrane fuel cell.

As illustrated in FIG. 1, the fuel cell 10 may include a plurality of unit cells 100 and end plates 510 and 520.

The unit cell 100 may include a membrane electrode assembly 1000, a gas diffusion layer 2000, and a separator 3000.

The membrane electrode assembly 1000 may have a conventional structure that includes an electrolyte membrane (not illustrated), an anode (not illustrated), and a cathode (not illustrated).

The electrolyte membrane (not illustrated) may be a polymer electrolyte formed with a thickness ranging from approximately 5 μm to approximately 200 μm, and may have an ion-exchange function that transfers hydrogen ions generated at the anode (not illustrated) to the cathode (not illustrated). Although in the present embodiment, the fuel cell 10 is exemplified as being formed a polymer electrolyte fuel cell, the present disclosure is not limited thereto and may be applied to various types of fuel cells.

The gas diffusion layer 2000 may be formed on at least one surface of the membrane electrode assembly 1000, and may be disposed between the separator 3000 and the membrane electrode assembly 1000. The gas diffusion layer 2000 may serve as a passage formed to transfer gas from the separator 3000 to the membrane electrode assembly 1000.

To achieve the aforementioned purpose, the gas diffusion layer 2000 may have a porous structure that allows gas to pass therethrough, and may be made of a conductive material to serve as a current conductor between the separator 3000 and the membrane electrode assembly 1000, which will be described later. For example, the gas diffusion layer 2000 may be formed of a porous conductive material, such as carbon cloth and paper or metal foam and fiber.

The separator 3000 may be disposed on at least one surface of the gas diffusion layer 2000, and may include a flow channel along which gas flows so that the gas is supplied to the gas diffusion layer 2000.

The fuel cell 10 may be improved in current density as gas convection between adjacent flow channels in the separator 3000 or gas diffusion into the gas diffusion layer 2000 becomes more active.

To this end, the fuel cell 10 may include a separator for fuel cells (hereinafter referred to as “separator 3000”) according to first to fourth embodiments. The separator 3000 according to the first to fourth embodiments may provide a flow channel structure capable of improving the current density, which will be described in detail later.

The plurality of unit cells 100 may be stacked between the end plates 510 and 520 that are disposed on outer sides of the unit cells 100.

The pair of end plates 510 and 520 may be disposed facing each other along the same axis with a gap therebetween. The end plate 510 on a first side may be formed with a fuel inlet (not illustrated) and a fuel outlet (not illustrated) for supplying or discharging fuel, while the end plate 520 on a second side may be formed with an oxidant inlet (not illustrated) and an oxidant outlet (not illustrated) for supplying or discharging an oxidant.

Fuel supplied to the end plate 510 on the first side through the fuel inlet (not illustrated) may pass through the separator 3000 and the gas diffusion layer 2000 and be supplied to the anode (not illustrated) of the membrane electrode assembly 1000. Oxidant supplied to the end plate 520 on the second side through the oxidant inlet (not illustrated) may pass through the separator 3000 and the gas diffusion layer 2000 and be supplied to the cathode (not illustrated) of the membrane electrode assembly 1000.

For example, the fuel may be formed of hydrogen gas or a hydrocarbon-based fuel containing hydrogen, and the oxidant may be formed of air containing oxygen gas or pure oxygen. In the present specification, the fuel and oxidant are collectively referred to as gas.

The end plates 510 and 520 may include a current collector plate configured to collect current, and an insulating plate for insulation.

Hereinafter, the separator according to the first embodiment of the present disclosure will be described.

FIG. 2A is a front view of the separator according to the first embodiment of the present disclosure. FIG. 2B is a sectional view illustrating a cross section of area A in a yz plane in FIG. 2A. For example, the separator 3000 illustrated in FIGS. 2A and 2B may be a cathode-side (reduction electrode-side) separator 3000.

As illustrated in FIG. 2A, the separator 3000 may include a body plate 3100, a serpentine flow channel 3210, and ribs 3300.

The body plate 3100 may have a thin plate shape, and may be disposed between the gas diffusion layer 2000 (refer to FIG. 1) and the end plate 510 (refer to FIG. 1) or between a plurality of gas diffusion layers 2000.

The body plate 3100 may be formed using materials such as stainless steel, titanium, and aluminum, which have excellent electrical conductivity, thermal conductivity, and corrosion resistance, as well as sufficient rigidity to serve as a structural support. However, the shape and material of the body plate 310 are not limited thereto, and various shapes and materials may be utilized.

An inlet 3110 through which gas is introduced may be formed on one side of the body plate 3100, and an outlet 3130 through which gas is discharged may be formed on another side.

The serpentine flow channel 3210 serves as a flow channel along which gas flows, and may be formed to connect the inlet 3110 and the outlet 3130 on one surface of the body plate 3100.

The serpentine flow channel 3210 may be formed to be recessed to a set depth on the surface of the body plate 3100, and may be integrally cast with the body plate 3100 or processed in an engraved form on a pre-cast body plate 3100.

The serpentine flow channel 3210 may include bent flow channels 3213, which is formed to be bent multiple times, and first main flow channels 3211 and second main flow channels 3212, which are formed without bending.

A portion of the gas flowing through the serpentine flow channel 3210 may diffuse into the gas diffusion layer 2000, or convection of a portion of the gas to other adjacent flow channels in the separator 3000 by passing over the ribs 3300 may occur.

Referring to FIG. 2B, the diffusion of gas from the separator 3000 to the gas diffusion layer 2000 may indicate that a portion of the gas flowing through the serpentine flow channel 3210 moves to the gas diffusion layer 2000 disposed in the +z direction.

As more gas diffuses, a greater amount of gas is supplied to the membrane electrode assembly 1000, which may enhance the current density of the fuel cell 10 (refer to FIG. 1).

Furthermore, the occurrence of convection of gas to an adjacent flow channel may indicate that gas in one flow channel bypasses the corresponding rib 3300 and moves to the adjacent flow channel.

For example, the foregoing indicates that a portion of the gas passing through the second main flow channels 3212 diffuses into the gas diffusion layer 2000 disposed in the +z direction, bypasses the ribs 3300, moves in the ±y direction, and then moves again in the −z direction to reach adjacent first main flow channels 3211.

In this way, convection to adjacent flow channels may be accompanied by the diffusion of gas into the gas diffusion layer 2000, and a portion of the gas diffused during the convection process may be supplied to the membrane electrode assembly 1000 separately from the previously diffused gas, thereby contributing to an improvement in current density.

The serpentine flow channel 3210 is bent multiple times and formed to be relatively long, thereby increasing a gas residence time and contact area, and enhancing the effect of gas diffusion into the gas diffusion layer 2000 or the effect of convection to adjacent flow channels.

Referring again to FIG. 2A, the first main flow channels 3211 may extend in the x direction and each be formed with a first width W1.

The second main flow channels 3212 may be spaced apart from the first main flow channels 3211, extend in the x direction, and each be formed with a second width W2.

The first width W1 may be formed larger than the second width W2. Specifically, the first width W1 may be formed at a ratio greater than 1 time and equal to or less than 2 times the second width W2. For example, in the case where the second width W2 is 0.8 mm, the first width W1 may be greater than 0.8 mm and equal to or less than 1.6 mm.

The first main flow channel 3211 and the second main flow channel 3212 may each be connected at one end thereof to the corresponding bent flow channel 3213 and may be arranged to face each other with the bent flow channel 3213 therebetween. Therefore, the direction of the gas passing through the first main flow channel 3211 may be opposite to the direction of the gas passing through the second main flow channel 3212.

The first main flow channel 3211 and the second main flow channel 3212 may be formed to be longer than the bent flow channel 3213, allowing the gas to remain for a longer period of time compared to the bent flow channel 3213. Accordingly, the first main flow channel 3211 and the second main flow channel 3212 may supply a greater amount of gas to the gas diffusion layer 3000 than the bent flow channel 3213.

Referring to FIG. 2A, the serpentine flow channel 3210 may have a structure in which the first main flow channels 3211 each having the relatively large first width W1 and the second main flow channel 3212 each having the relatively small second width W2 are alternately arranged along one direction.

For example, one of the first main flow channels 3211 may be first placed at an uppermost position in the +y direction to be connected to the inlet 3110, and the second main flow channels 3212 with a relatively small width and the other first main flow channels 3211 with a relatively large width may be alternately repeated in the −y direction.

Assuming that the first main flow channel 3211 and the second main flow channel 3212 have the same flow channel depth, the pressure of gas flowing through the flow channel is greater in the second main flow channel 3212 than in the first main flow channel 3211, thereby generating a pressure difference between the first main flow channel 3211 and the second main flow channel 3212.

Accordingly, in the case where the first main flow channels 3211 and the second main flow channels 3212 are alternately arranged adjacent to each other, a convection phenomenon, in which gas moves from one flow channel to other adjacent flow channel over the ribs 3300, may become more active due to a pressure difference.

During the aforementioned process, the gas passes through the gas diffusion layer 2000 disposed in the +z direction of the body plate 3100, thereby increasing the amount of gas supplied to the gas diffusion layer 2000, and improving the current density of the fuel cell 10 (see FIG. 1).

In FIG. 2A, the serpentine flow channel 3210 is depicted as having the first main flow channel 3211 first placed at the uppermost position in the +y direction to be connected to the inlet 3110. However, the present disclosure is not limited to the aforementioned example, and the second main flow channel 3212 may be first placed at the uppermost position in the +y direction to be connected to the inlet 3110.

The bent flow channels 3213 may each be formed in a bent shape between the corresponding first main flow channel 3211 and the corresponding second main flow channel 3212, with one end connected to the first main flow channel 3211 and a remaining end connected to the second main flow channel 3212.

Referring to FIG. 2A, the bent flow channel 3213 may be disposed perpendicularly to the first main flow channel 3211 and the second main flow channel 3212, but is not limited to the aforementioned shape. The bent flow channel 3213 may be disposed in an oblique shape by forming an acute angle between the first main flow channel 3211 and the second main flow channel 3212, or may be disposed in an arc shape with curvature.

In the case where the bent flow channel 3213 is disposed in an oblique or curved shape rather than perpendicularly to the main flow channels 3211 and 3212, a momentum loss of the gas moving from the first main flow channel 3211 to the bent flow channel 3213 and from the bent flow channel 3213 to the second main flow channel 3212 may be reduced, allowing the gas to maintain a higher speed. As a result, gas diffusion or convection to the gas diffusion layer 2000 may become more active.

The bent flow channels 3213 may each be formed with the first width W1 or the second width W2, or alternatively, may be formed with any width.

Each of the ribs 3300, as a part of the body plate 3100, may be formed at the same height as the surface of the body plate 3100 or may protrude in the +z direction from the surface of the body plate 3100.

The rib 3300 may be formed in a shape enclosed by the first main flow channel 3211, the second main flow channel 3212, and the bent flow channel 3213, thereby partitioning a boundary of each flow channel.

Hereinafter, the separator according to the second embodiment of the present disclosure will be described.

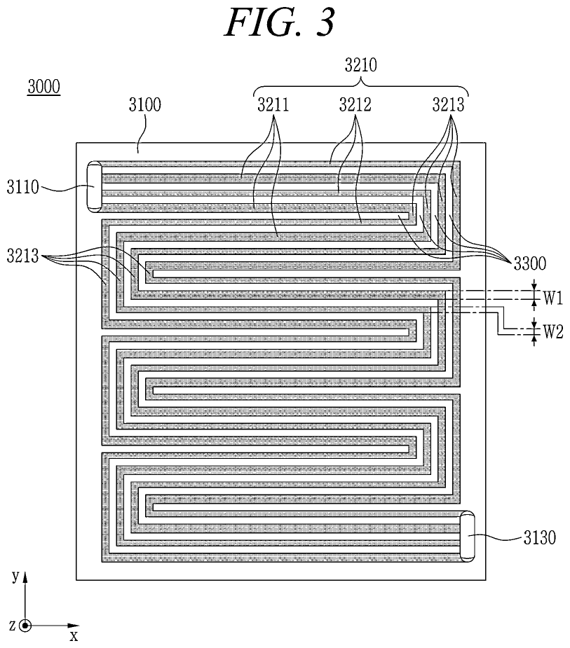

FIG. 3 is a front view illustrating the separator according to the second embodiment of the present disclosure.

The second embodiment is identical to the aforementioned first embodiment except that a plurality of serpentine flow channels 3210 are provided, in each of which first main flow channels 3211 and second main flow channels 3212 are alternately arranged. Therefore, redundant descriptions of the same configuration are omitted.

In addition, hereinafter, the term “serpentine flow channel 3210” refers to a single serpentine flow channel 3210 that is continuously connected from the inlet 3110 to the outlet 3130 without interruption.

Referring to FIG. 3, the separator 3000 may be provided with a plurality of serpentine flow channels 3210, and the plurality of serpentine flow channels 3210 may be arranged so as not to intersect with each other.

In this case, among a pair of adjacent serpentine flow channels 3210, the first main flow channels 3211 of one serpentine flow channel 3210 may be alternately arranged with the second main flow channels 3212 of a remaining one serpentine flow channel 3210.

In other words, in any one of the plurality of serpentine flow channels 3210, the first main flow channels 3211 and the second main flow channels 3212 may be alternately arranged, and the overall structure of the plurality of serpentine flow channels 3210 may also satisfy the arrangement in which the first main flow channels 3211 and the second main flow channels 3212 are alternately arranged.

As described above, the pressure of gas passing through the flow channel is greater in the second main flow channels 3212 than in the first main flow channels 3211.

Furthermore, even in a single flow channel, the wider the flow channel, the smaller a pressure drop along a flow direction, and the narrower the flow channel, the greater the pressure drop.

In summary, gas supplied to the inlet 3110 at the same pressure has a higher initial pressure when passing through the second main flow channel 3212 than when passing through the first main flow channel 3211. However, as the gas flows through the flow channels, the pressure decreases more significantly in the second main flow channel 3212, and eventually, the pressure in the second main flow channel 3212 may become lower than the pressure in the first main flow channel 3211.

Accordingly, a differential pressure between the adjacent second main flow channel 3212 and first main flow channel 3211 gradually decreases along the flow direction while maintaining a positive value, becomes zero at a certain point, and increases in magnitude with a negative value downstream of that point.

As described above, in the case where the differential pressure between the adjacent first main flow channel 3211 and second main flow channel 3212 increases, the convection effect may become more active, thereby increasing the amount of gas supplied to the gas diffusion layer 2000 and enhancing the current density of the fuel cell 10.

Furthermore, as the plurality of serpentine flow channels 3210 are provided, the gas contact area becomes wider, thereby enhancing the degree of gas diffusion from the separator 3000 to the gas diffusion layer 2000.

In FIG. 3, four serpentine flow channels 3210 are illustrated as being connected to each of the inlet 3110 and the outlet 3130, but are not limited thereto. For example, an even number of serpentine flow channels, such as two or six, may be connected.

Furthermore, In FIG. 3, the serpentine flow channels 3210 are depicted as having the second main flow channel 3212 first placed at the uppermost position in the +y direction to be connected to the inlet 3110. However, the present disclosure is not limited to the aforementioned example, and the first main flow channel 3211 may be first placed at the position portion in the +y direction to be connected to the inlet 3110.

Hereinafter, the effect of the separator according to the second embodiment of the present disclosure will be described.

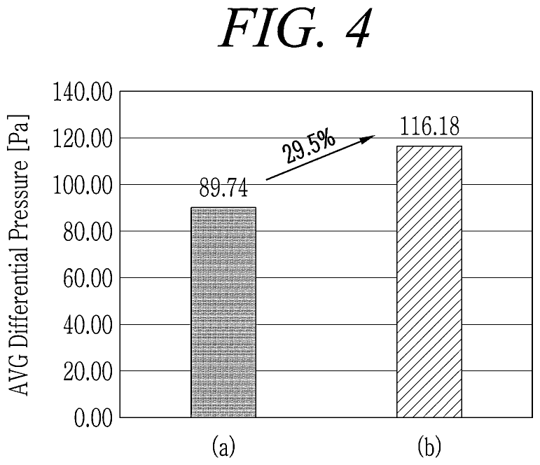

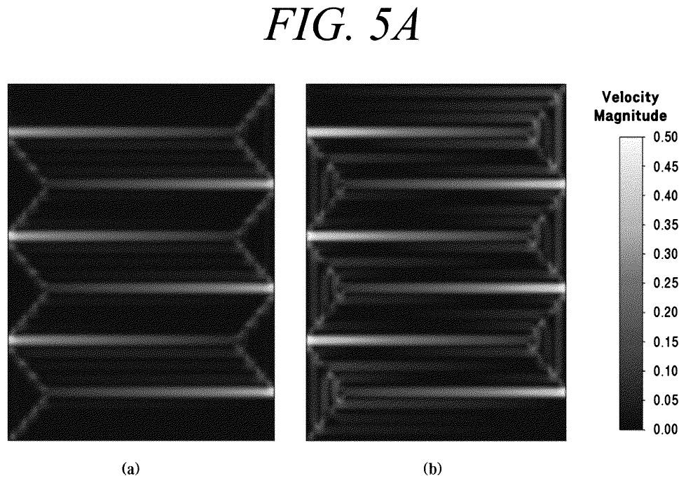

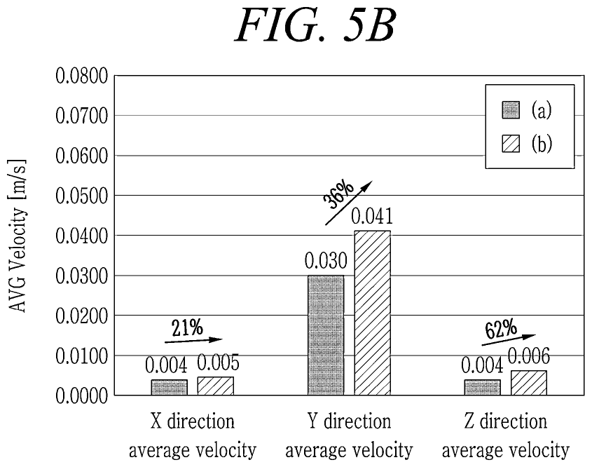

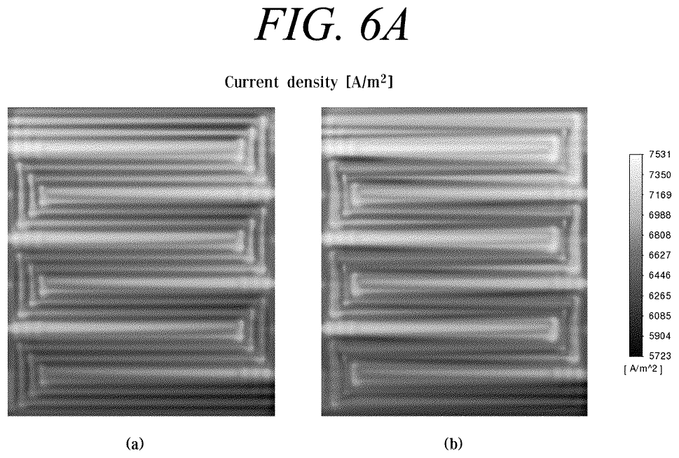

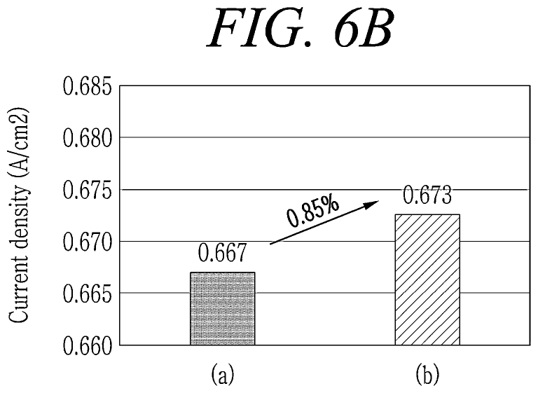

FIG. 4 is a graph comparing an average differential pressure in a flow channel of the separator in the second embodiment with that in the prior art. FIG. 5A is a diagram comparing a gas flow velocity in a gas diffusion layer between the second embodiment and the prior art. FIG. 5B is a graph numerically comparing the flow velocity shown in FIG. 5A. FIG. 6A is a diagram comparing a current density between the second embodiment and the prior art. FIG. 6B is a graph numerically comparing the current density shown in FIG. 6A.

In FIGS. 4 to 6B, (a) represents a conventional separator with a uniform flow channel width of 1 mm, and (b) represents the separator 3000 according to the second embodiment of the present disclosure.

Referring to FIG. 4, the average differential pressure between the flow channels in the separator is 89.74 Pa in the case of the conventional separator (a) with a uniform flow channel width, and 116.18 Pa in the case of the separator (b) according to the second embodiment, indicating that the separator (b) according to the second embodiment is improved by 29.5% p compared to the conventional separator (a).

As the differential pressure between the flow channels increases, the convection of gas between adjacent flow channels in the separator 3000 may become more active. The degree of convection can be identified through flow velocity (speed) data, which represents the momentum of the gas. Accordingly, the gas flow velocity in the gas diffusion layer 2000 will hereinafter be compared with reference to FIGS. 5A and 5B.

Referring to FIG. 5A, it can be confirmed that the gas flow velocity in the gas diffusion layer 2000 is faster when the separator (b) according to the second embodiment is applied compared to the case where the conventional separator (a) is applied.

Referring to FIG. 5B, which numerically compares the data from FIG. 5A, it can be confirmed that a y-direction average velocity is improved by 36% p and a z-direction average velocity is improved by 62% p when the separator (b) according to the second embodiment is applied, compared to the case where the conventional separator (a) is applied.

In summary, in the case of the separator (b) according to the second embodiment, the differential pressure between the flow channels in the separator 3000 increases compared to the conventional separator (a). As a result, the increased convection of gas between adjacent main flow channels 3211 and 3212 with different widths can be identified through the increase in the y-direction flow velocity, and the improved diffusion of gas from the separator 3000 to the gas diffusion layer 2000 can be identified through the increase in the z-direction flow velocity.

As convection and diffusion become more active, the amount of gas supplied to the membrane electrode assembly 1000 (refer to FIG. 1) increases, thereby improving the current density. The foregoing will be explained with reference to FIG. 6A, which compares the current density between the second embodiment and the prior art, and FIG. 6B, which numerically compares the data from FIG. 6A.

Referring to FIG. 6A, it can be confirmed that the current density is generally higher when the separator (b) according to the second embodiment is used compared to the case where the conventional separator (a) is used.

Specifically, referring to FIG. 6B, it can be confirmed that the current density is 0.667 A/cm² in the case where the conventional separator (a) is used, and 0.673 A/cm² in the case where the separator (b) according to the second embodiment is used, indicating an improvement of 0.85% p compared to the conventional art.

Hereinafter, the separator according to the third embodiment of the present disclosure will be described.

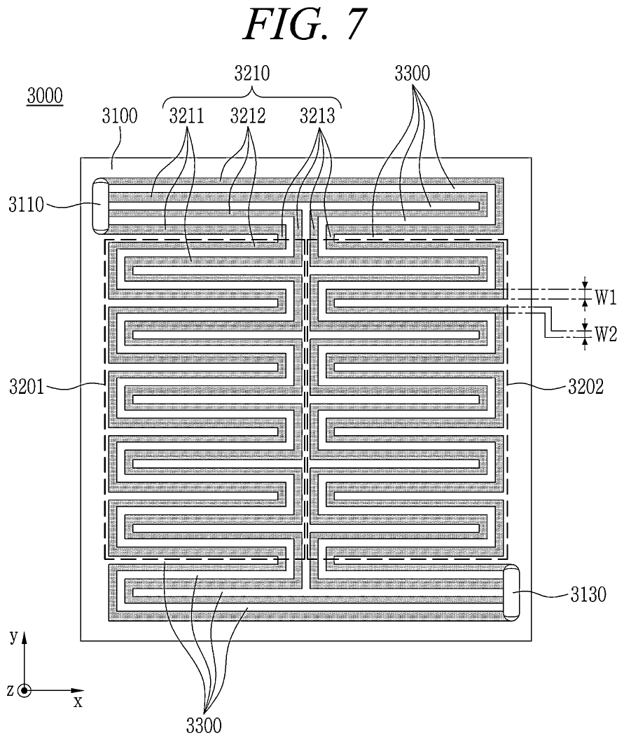

FIG. 7 is a front view illustrating a separator according to the third embodiment of the present disclosure.

The third embodiment is identical to the aforementioned second embodiment except that the third embodiment further includes a first flow channel assembly 3201 and a second flow channel assembly 3202. Therefore, redundant descriptions of the same configuration are omitted.

Referring to FIG. 7, the separator 3000 may further include a first flow channel assembly 3201 and a second flow channel assembly 3202, each of which includes a plurality of serpentine flow channels 3210.

In this case, the first flow channel assembly 3201, which includes a plurality of serpentine flow channels 3210, may be formed as in the second embodiment, and the second flow channel assembly 3202 may be formed symmetrically with respect to the first flow channel assembly 3201.

For example, the first flow channel assembly 3201, which includes a plurality of serpentine flow channels 3210, may be arranged on a left side, and the second flow channel assembly 3202, which is formed symmetrically with respect to the first flow channel assembly 3201, may be arranged on a right side, so that the serpentine flow channels 3210 may be arranged in two sections, left and right sections, on the body plate 3100.

In this case, the first main flow channels 3211 and the second main flow channels 3212 included in the first flow channel assembly 3201 and the second flow channel assembly 3202 may be formed to be shorter than the first main flow channels 3211 and second main flow channels 3212 in the aforementioned embodiments.

Accordingly, since the gas flows through the shorter first main flow channels 3211 and the shorter second main flow channels 3212, the pressure drop may be reduced compared to the aforementioned embodiments.

Therefore, the gas may flow through the first main flow channels 3211 and the second main flow channels 3212 while maintaining a higher pressure and diffuse into the gas diffusion layer 2000.

Furthermore, since the first flow channel assembly 3201 and the second flow channel assembly 3202 have the first main flow channels 3211 and the second main flow channels 3212 alternately arranged, the convection effect may become more active due to the differential pressure between the flow channels.

The lengths of the first main flow channel 3211 and the second main flow channel 3212 that connect the inlet 3110 and the second flow channel assembly 3202 may be formed to be relatively long, and the lengths of the first main flow channel 3211 and the second main flow channel 3212 that connect the outlet 3130 and the first flow channel assembly 3201 may also be formed to be relatively long.

However, even in this case, the flow channel assemblies 3201 and 3202 may be formed such that the first main flow channel 3211 and the second main flow channel 3212 are alternately arranged overall.

Hereinafter, the effect of the separator according to the third embodiment of the present disclosure will be described.

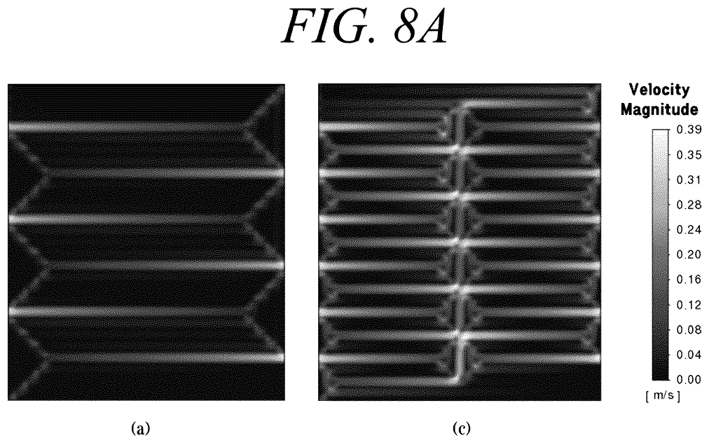

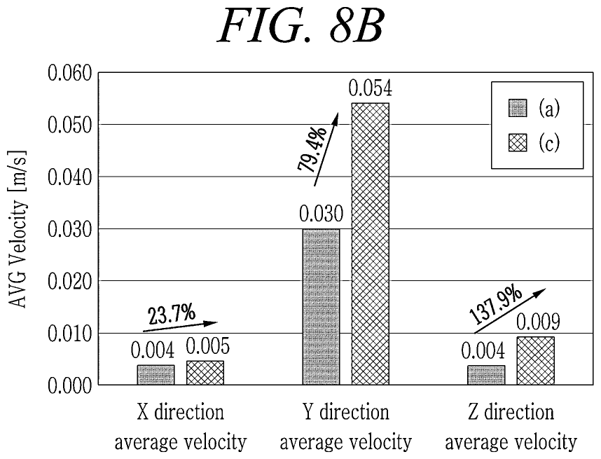

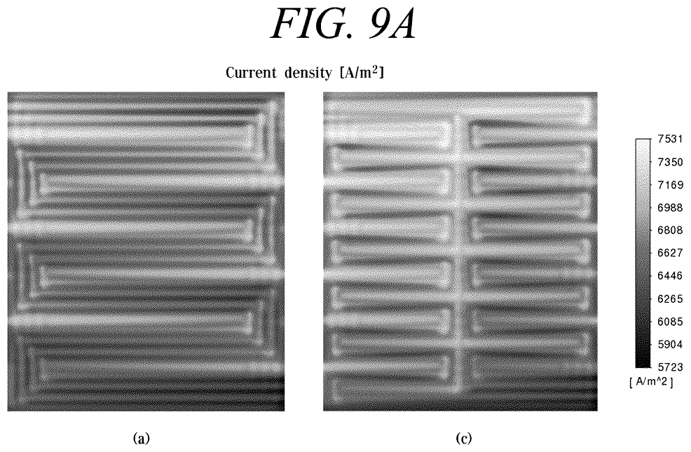

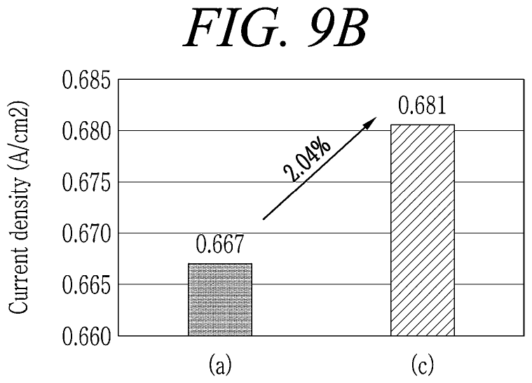

FIG. 8A is a diagram comparing a flow velocity of gas in the gas diffusion layer between the third embodiment and the prior art. FIG. 8B is a graph numerically comparing the flow velocity shown in FIG. 8A. FIG. 9A is a diagram comparing a current density between the third embodiment and the prior art. FIG. 9B is a graph numerically comparing the current density shown in FIG. 9A.

In FIGS. 8A to 9B, (a) represents a conventional separator with a uniform flow channel width of 1 mm, and (c) represents the separator 3000 according to the third embodiment of the present disclosure.

The effect according to the third embodiment is identical to the effect according to the second embodiment, except for specific numerical values, and therefore, redundant explanations regarding the same effect are omitted.

Referring to FIG. 8A, it can be confirmed that the gas flow velocity in the gas diffusion layer 2000 is generally faster when the separator (b) according to the third embodiment is applied compared to the case where the conventional separator (a) is applied.

Referring to FIG. 8B, which numerically compares the data from FIG. 8A, it can be confirmed that a y-direction average velocity is improved by 79.4% p and a z-direction average velocity is improved by 137.9% p when the separator (c) according to the third embodiment is applied, compared to the case where the conventional separator (a) is applied.

It can be seen that the gas convection between adjacent parallel flow channels 3211a and 3211b, which have different widths, is active, and that gas diffusion from the separator 3000 to the gas diffusion layer 2000 is improved, as indicated by the significant increases in the gas flow velocities in the y-direction and z-direction.

Referring to FIG. 9A, it can be confirmed that the current density is generally higher when the separator (c) according to the third embodiment is used compared to the case where the conventional separator (a) is used.

Specifically, referring to FIG. 9B, it can be confirmed that the current density is 0.667 A/cm² in the case where the conventional separator (a) is used, and 0.681 A/cm² in the case where the separator (c) according to the third embodiment is used, indicating an improvement of 2.04% p compared to the conventional art.

Hereinafter, the separator according to the fourth embodiment of the present disclosure will be described.

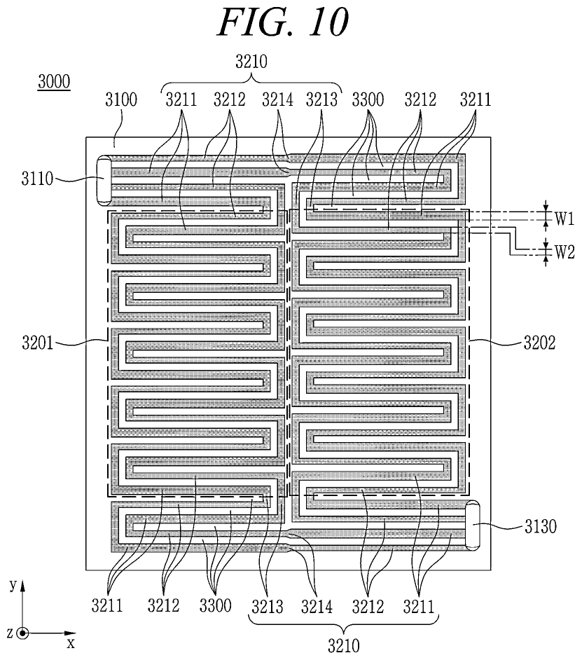

FIG. 10 is a front view illustrating the separator according to the fourth embodiment of the present disclosure.

The fourth embodiment is identical to the aforementioned third embodiment except that the arrangement of the second flow channel assembly 3202 is changed, and an additional modified section 3214 is included. Therefore, redundant descriptions of the same configuration are omitted.

Referring to FIG. 10, the arrangement order of the first main flow channels 3211 and the second main flow channels 3212 in the first flow channel assembly 3201 may be opposite to the arrangement order of the first main flow channels 3211 and the second main flow channels 3212 in the second flow channel assembly 3202.

Specifically, if the plurality of serpentine flow channels 3210 in the first flow channel assembly 3201 are arranged in such a way that the second main flow channel 3212 is placed first at the uppermost position in the +y direction in a region of the first flow channel assembly 3201, followed by alternating arrangement of the first main flow channels 3211 and the second main flow channels 3212 in the −y direction, the plurality of serpentine flow channels 3210 in the second flow channel assembly 3202 may, conversely, be arranged such that the first main flow channel 3211 is placed first, followed by alternating arrangement of the second main flow channels 3212 and first main flow channels 3211 in the −y direction.

According to the above structure, the first main flow channels 3211 of the first flow channel assembly 3201 may be respectively aligned at the same y-coordinates with the second main flow channels 3212 of the second flow channel assembly 3202. The second main flow channels 3212 of the first flow channel assembly 3201 may be respectively aligned at the same y-coordinates with the first main flow channels 3211 of the second flow channel assembly 3202. Therefore, a pressure difference may also occur between the first flow channel assembly 3201 and the second flow channel assembly 3202, thereby facilitating active convection between adjacent main flow channels 3211 and 3212 in the x-direction.

Each of the serpentine flow channels 3210 may further include a modified section 3214.

The modified section 3214 may be disposed in the first main flow channel 3211 or the second main flow channel 3212, and may be a section where the width of the first main flow channel 3211 is reduced to the second width W2, or the width of the second main flow channel 3212 is increased to the first width W1.

Specifically, the modified section 3214 may be disposed in each of the first main flow channel 3211 and the second main flow channel 3212 that connect the inlet 3110 to the second flow channel assembly 3202, and may also be disposed in each of the first main flow channel 3211 and the second main flow channel 3212 that connect the outlet 3130 to the first flow channel assembly 3201.

While passing through the modified section 3214, the first main flow channel 3211 may be reduced in width, thereby forming the second main flow channel 3212. While passing through the modified section 3214, the second main flow channel 3212 may be increased in width, thereby forming the first main flow channel 3211.

In the case where the modified section 3214, where the width changes as described above, is included, the plurality of serpentine flow channels 3210 can satisfy a structure in which the first main flow channels 3211 and the second main flow channels 3212 are alternately arranged overall, even if the second flow channel assembly 3202 is arranged in the reverse order of the first flow channel assembly 3201.

As described above, in a separator for fuel cells and a fuel cell including the separator according to embodiments of the present disclosure, convection of gas between adjacent flow channels in the separator and diffusion of gas into a gas diffusion layer may be facilitated, thereby improving a current density of the fuel cell.

While the present disclosure has been described with respect to the specific embodiments, it will be apparent to those skilled in the art that various changes or modifications of the present disclosure are possible by adding, changing, or deleting components without departing from the spirit and scope of the present disclosure as defined in the following claims. It should be noted that these changes or modifications also fall within the bounds of the present disclosure.

What is claimed is:

1. A separator for fuel cells, comprising:
a body plate; and
a serpentine flow channel formed on one surface of the body plate,
wherein the serpentine flow channel comprises:
a first main flow channel formed with a first width;
a second main flow channel spaced apart from the first main flow channel and formed with a second width; and
a bent flow channel connected at one end thereof to the first main flow channel, and connected at another end thereof to the second main flow channel, and
wherein the first width is greater than the second width.

2. The separator according to claim 1, further comprising a rib enclosed by the first main flow channel, the second main flow channel, and the bent flow channel.

3. The separator according to claim 1, wherein the first main flow channel and the second main flow channel are alternately arranged along one direction.

4. The separator according to claim 3, wherein the serpentine flow channel comprises a plurality of serpentine flow channels, and
wherein the first main flow channel of one serpentine flow channel of a pair of adjacent serpentine flow channels among the plurality of serpentine flow channels is alternately arranged with the second main flow channel of a remaining serpentine flow channel of the pair of adjacent serpentine flow channels.

5. The separator according to claim 4, further comprising a first flow channel assembly and a second flow channel assembly each comprising the plurality of serpentine flow channels.

6. The separator according to claim 5, wherein the first flow channel assembly and the second flow channel assembly are symmetrical with each other.

7. The separator according to claim 5, wherein an arrangement order of the first main flow channel and the second main flow channel in the first flow channel assembly is opposite to an arrangement order of the first main flow channel and the second main flow channel in the second flow channel assembly.

8. The separator according to claim 7, wherein the serpentine flow channel further comprises a modified section in which the width of the first main flow channel is reduced to the second width, or the width of the second main flow channel is increased to the first width.

9. A fuel cell, comprising:
a membrane electrode assembly;
a gas diffusion layer formed on at least one surface of the membrane electrode assembly; and
a separator configured to supply gas to the gas diffusion layer,
wherein the separator comprises the separator according to claim 1.
